(19) United States
(12) Patent Application Publication
(10) Pub. No.: US 2018/0359957 A1
(43) Pub. Date: Dec. 20, 2018

(54) SYSTEMS AND METHODS FOR PROVIDING AN EXTERNAL NOTIFICATION OF A GROW POD STATUS

(71) Applicant: Grow Solutions Tech LLC, Lehi, UT (US)

(72) Inventors: Gary Bret Millar, Highland, UT (US); Mark Gerald Stott, Eagle Mountain, UT (US); Michael Stephen Hurst, Farmington, UT (US)

(21) Appl. No.: 15/991,199

(22) Filed: May 29, 2018

Related U.S. Application Data
(60) Provisional application No. 62/519,304, filed on Jun. 14, 2017.
(60) Provisional application No. 62/519,416, filed on Jun. 14, 2017.

(51) Int. Cl. A01G 9/26; H04L 29/08; A01G 7/04; A01G 9/02; G06Q 50/02

(52) U.S. Cl. CPC A01G 9/26; H04L 67/12; G06Q 50/02; A01G 9/02; A01G 7/045

(57) ABSTRACT

An assembly line grow pod notification system includes a status indicator and a cart containing one or more plants therein. The cart includes one or more sensors and a cart-computing device communicatively coupled to the one or more sensors and the status indicator, the cart-computing device comprising a processor and a non-transitory, processor-readable storage medium comprising one or more programming instructions thereon. When executed, the one or more programming instructions cause the processor to receive, from the one or more sensors, one or more signals that correspond to a status of the cart and one or more characteristics of the one or more plants, determine information regarding the status from the one or more signals, and direct the status indicator to output a notification signal that corresponds to the determined information.

### CROSS-REFERENCE TO RELATED APPLICATIONS

This application claims the benefit of U.S. Provisional Application No. 62/519,304, filed Jun. 14, 2017, and the benefit of U.S. Provisional Application No. 62/519,416, filed Jun. 14, 2017, the contents of which are hereby incorporated by reference in their respective entireties.

### TECHNICAL FIELD

Embodiments described herein generally relate to systems and methods for providing an assembly line grow pod and, more specifically, to an assembly line grow pod including status indicators for providing information regarding the grow pod, a component thereof, and/or or a seed or plant.

### BACKGROUND

While crop growth technologies have advanced over the years, there are still many problems in the farming and crop industry today. As an example, while technological advances have increased efficiency and production of various crops, many factors may affect a harvest such as weather, disease, infestation, and the like. Additionally, while the United States currently has suitable farmland to adequately provide food for the U.S. population, other countries and future populations may not have enough farmland to provide the appropriate amount of food.

Greenhouses typically do not provide automation or environment control, and therefore typically provide little to no ability to control or improve the growth of a plant. As such, greenhouses do not determine the status of a growing system, components therein and/or the status of plants, seeds, and seedlings within the system. Moreover, automated growing systems also do not provide status monitoring capabilities.

Accordingly, there exists a need for a notification system for a grow pod to provide the status of the assembly line grow pod, components thereof, and the plants, seeds, and seedlings growing therein.

### SUMMARY

In one embodiment, an assembly line grow pod notification system includes a status indicator and a cart containing one or more plants therein. The cart includes one or more sensors and a cart-computing device communicatively coupled to the one or more sensors and the status indicator, the cart-computing device comprising a processor and a non-transitory, processor-readable storage medium comprising one or more programming instructions thereon. When executed, the one or more programming instructions cause the processor to receive, from the one or more sensors, one or more signals that correspond to a status of the cart and one or more characteristics of the one or more plants, determine information regarding the status from the one or more signals, and direct the status indicator to output a notification signal that corresponds to the determined information.

In another embodiment, an assembly line grow pod includes a master controller and a cart. The cart includes a tray supporting a plurality of plants. The assembly line grow pod further includes a cart-computing device communicatively coupled to the master controller and one or more sensors communicatively coupled to the cart-computing device. The one or more sensors generate one or more signals corresponding sensed information relating to at least one of the following: the cart or the plurality of plants. The cart-computing device performs at least the following: receive, from the one or more sensors, the one or more signals, determine whether the one or more signals indicate an issue, and transmit a notification to the master controller indicating the issue. The master controller performs at least the following: receives, from the cart-computing device, the notification indicating the issue, determines a criticality of the issue, and generates a visualization of the issue where the visualization indicates the criticality of the issue.

In another embodiment, a method for providing a status of an assembly line grow pod includes receiving, from one or more sensors within the assembly line grow pod, one or more signals corresponding to information relating to at least one of the following: a water level, an air characteristic, a temperature, a pressure, a lighting condition, a measured amount of plant growth, a measured plant color, a measured amount of contaminants, a measured pH, or a measured amount of nutrients, a status of a communications link between cart components, a status of a communications link between the cart and components external to the cart, an amount of electrical power supplied to the cart, cart movement characteristics, or a cart component failure indicator. The method further includes determining whether the one or more signals indicate an issue; generating a visualization for the issue; and causing a display to present the visualization of the issue.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an enclosure for a grow pod, according to one or more embodiments shown and described herein;

FIG. 2A schematically depicts a first view of an assembly line grow pod, according to one or more embodiments shown and described herein;

FIG. 2B schematically depicts a second view of the assembly line grow pod, according to one or more embodiments shown and described herein;

FIG. 3 schematically depicts a plurality of illustrative carts supporting a payload in an assembly line configuration according to one or more embodiments shown and described herein;

FIG. 4 schematically depicts a notification system for an assembly line grow pod, according to one or more embodiments shown and described herein;

FIG. 5 schematically depicts various components of an illustrative cart-computing device for facilitating communications according to one or more embodiments shown and described herein;

FIG. 6 schematically depicts an assembly line grow pod status interface for indicating a status with the grow pod, according to one or more embodiments shown and described herein; and

FIG. 7 depicts a flowchart for providing a status of the grow pod, according to one or more embodiments shown and described herein.

### DETAILED DESCRIPTION

Embodiments disclosed herein include systems and methods for providing notification for an assembly line grow pod where the notification includes a status of the grow pod or components thereof. Embodiments of the grow pod include an assembly line configuration such that a cart supporting a payload travels on a track of a grow pod to provide sustenance (such as light, water, nutrients, etc.) to seeds and/or plants included in the payload on the cart. The cart may be among one or more other carts arranged on the track of the grow pod to create an assembly line of carts. These embodiments may be configured with a notification system to provide a status of the assembly line grow pod, a component thereof, and/or plant material (e.g., a plurality of plants, seeds and/or seedlings) growing therein. The notification system may include one or more sensors configured to monitor the assembly line grow pod, the components thereof, and/or plant material for issues. The embodiments may utilize a display, a communication module, status indicators, or light devices for providing indicators of the status of the assembly line grow pod, a component thereof, and/or plant material growing therein. The systems and methods for providing an assembly line grow pod incorporating the same is described in more details below.

As used herein, “plant material” refers to the one or more plants, seeds, and/or seedlings configured within the cart for growing. In some embodiments, the cart includes a tray where the plants, seeds and/or seedlings are retained for growing as the cart traverses the track. Additionally, “plant material” may further refer to the crop and/or fruits produced from the plants, seeds, and/or seedlings.

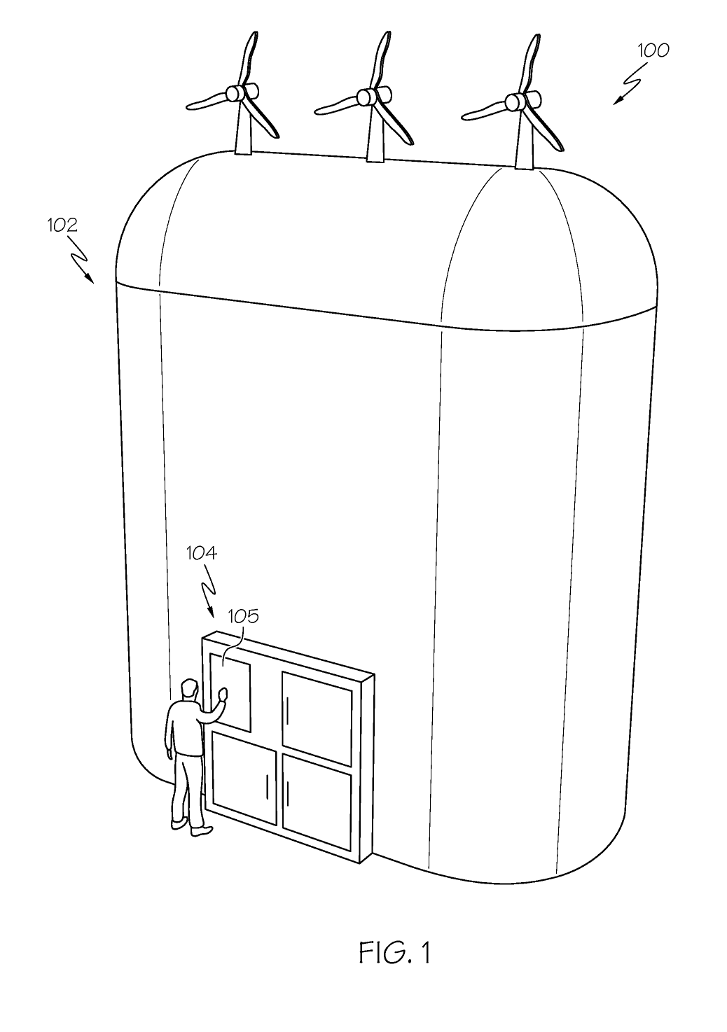

Referring now to the drawings, FIG. 1 depicts a grow pod 100 according to embodiments described herein. As illustrated, the grow pod 100 includes an enclosure 102. The grow pod 100 may be a self-contained unit that maintains an environment inside the enclosure 102 and shields the interior of the grow pod 100 from external environmental conditions. In some embodiments, coupled to the enclosure 102 is a display 104 (e.g., a control panel) optionally incorporating an input device 105 such as a touch input, keyboard, mouse, or the like. The display 104 on the exterior of the enclosure 102 of the grow pod 100 may indicate a status of the grow pod 100 and/or any issues as provided in examples herein or issues that a user may desire information on that relate to the assembly line grow pod, components thereof, and/or the growth of the plants therein.

As used herein, “status” refers to the operational state of a component or system of the assembly line grow pod and/or the condition of a component and/or the plant material, with respect to a predetermined or predefined measure. For example, the status of a battery may refer to the level of charge or the status of a drive motor may be whether the drive motor is on or off, whether it is operating in a forward direction or reverse direction, the power (e.g., voltage and current) being provided to it to operate and/or an operational state of the cart. In some embodiments, the operational state of the cart includes a status of a communications link between cart components external to the cart, an amount of electrical power supplied to the cart, cart movement characteristics, or cart component failure indicators. That is, the status refers to information regarding the plant material, the assembly line grow pod, and/or a component thereof. Furthermore, a status may be the condition of a component, plant, seed, or seedling with respect to a predetermined of predefined measure. For example, plant growth after a particular amount of time may be predefined to be 10 cm to 15 cm in height. Therefore, if the one or more sensors indicate the plant height is within the range of 10 cm to 15 cm then the status may be that the plant is growing as expected (e.g., status is normal). However, if the plant growth is outside the predefined range of height then the status may be that the plant is not growing as expected. In such an instance, the status would indicate an issue.

As used herein, “issue” refers to an operational state or condition of a component, plant, seed, or seedling of the assembly line grow pod that is not as expected. For example, if a driver motor receives a control signal to operate in the forward direction but fails to turn on then the status may be that there is an issue with the drive motor. That is, the issue is that the drive motor did not respond as it was instructed. By way of another example, if the color of a plant is determined to be green-brown from one or more of the sensors whereas it should be light green, then the status may be that there is an issue with the color of the plant. These are only a few examples of a status and issues that the notification system may indicate and others may be within the scope of the present disclosure. Furthermore, it should also be understood that these are merely exemplary and are not intended to limit the scope of this disclosure.

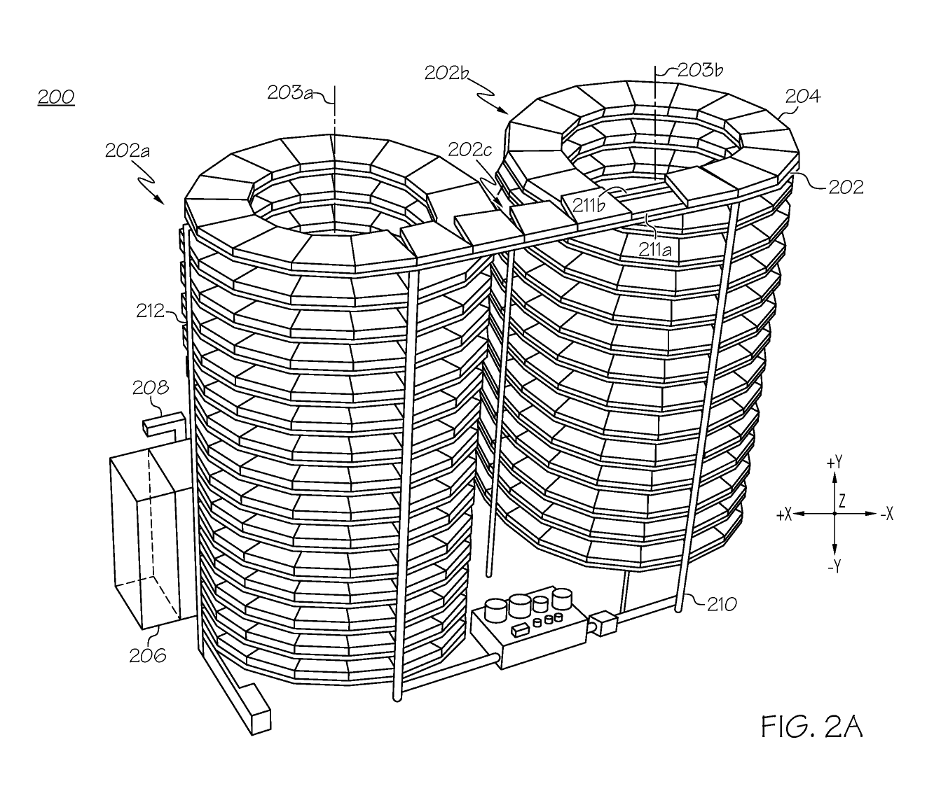

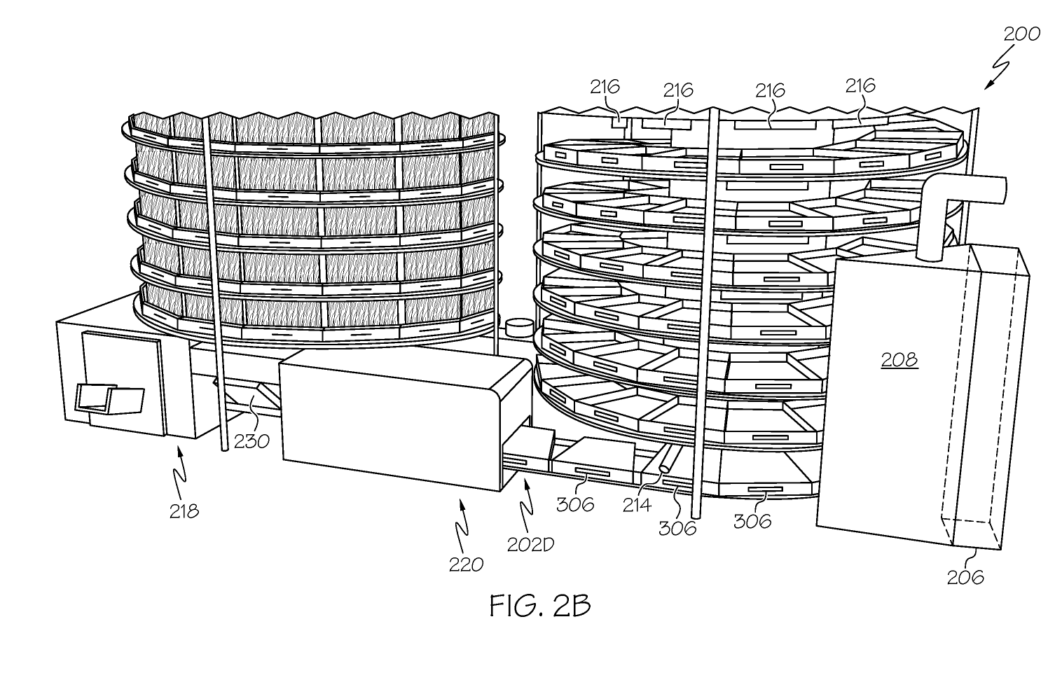

Referring now to FIGS. 2A and 2B, various interior components of the assembly line grow pod 200 are depicted. The various components of the assembly line grow pod 200 may be arranged within the enclosure 102 of the grow pod 100. As illustrated, the assembly line grow pod 200 may include a track 202 that holds one or more carts 204. The track 202 may include an ascending portion 202a, a descending portion 202b, a first connection portion 202C, and a second connection portion 202d (FIG. 2B). The track 202 may wrap around (e.g., in a counterclockwise direction in FIGS. 2A and 2B, although clockwise or other configurations are also contemplated) a first axis 203a such that the carts 204 ascend upward in a vertical direction (e.g., in the +Y direction of the coordinate axes of FIG. 2A). The first connection portion 202c may be relatively level (although this is not a requirement) and may be utilized to transfer carts 204 to the descending portion 202b. The descending portion 202b may be wrapped around a second axis 203b (e.g., in a counterclockwise direction in FIGS. 2A and 2B) that is substantially parallel to the first axis 203a, such that the carts 204 may be returned closer to ground level (e.g., towards the −Y direction of the coordinate axes of FIG. 2A).

In some embodiments, a second connection portion 202d (shown in FIG. 2B) may be positioned near ground level that couples the descending portion 202b to the ascending portion 202a such that the carts 204 may be transferred from the descending portion 202b to the ascending portion 202a. Similarly, some embodiments may include more than two connection portions to allow different carts 204 to travel different paths. As an example, some carts 204 may continue traveling up the ascending portion 202a, while some may take one of the connection portions before reaching the top of the assembly line grow pod 200.

Also depicted in FIG. 2A is a master controller 206. The master controller 206 may include an input device 105, an output device and/or other components. The master controller 206 may be coupled to a nutrient dosing component, a water distribution component, a seeder component 208, and/or other hardware for controlling various components of the assembly line grow pod 200.

The seeder component 208 may be configured to provide seeds to one or more carts 204 as the carts 204 pass the seeder in the assembly line. Depending on the particular embodiment, each cart 204 may include a tray 230 (FIG. 2B) for receiving a plurality of seeds. In some embodiments, the tray 230 may be a multiple section tray for receiving individual seeds in each section (or cell) or receiving a plurality of seeds in each cell. The seeder component 208 may detect a presence of the respective cart 204 and may begin laying seed across an area of the cells within the tray 230. The seed may be laid out according to a desired depth of seed, a desired number of seeds, a desired surface area of seeds, and/or according to other criteria. In some embodiments, the seeds may be pre-treated with nutrients and/or anti-buoyancy agents (such as water) as these embodiments may not utilize soil to grow the seeds and thus might need to be submerged.

The watering component may be coupled to one or more water lines 210, which distribute water and/or nutrients to one or more trays 230 (FIG. 2B) at predetermined areas of the assembly line grow pod 200. In some embodiments, seeds may be sprayed to reduce buoyancy and then watered. Additionally, water usage and consumption may be monitored, such that at subsequent watering stations, this data may be utilized to determine an amount of water to apply to a seed at that time.

Also depicted in FIG. 2A are airflow lines 212. Specifically, the master controller 206 may include and/or be coupled to one or more components that delivers airflow for temperature control, pressure, carbon dioxide control, oxygen control, nitrogen control, etc. Accordingly, the airflow lines 212 may distribute the airflow at predetermined areas in the assembly line grow pod 200.

Referring now to FIG. 2B, a second view of the assembly line grow pod 200 illustrating a plurality of components of an assembly line grow pod 200 is depicted. As illustrated, the seeder component 208 is illustrated, as well as lighting devices 216, a harvester component 218, and a sanitizer component 220.

The assembly line grow pod 200 may include a plurality of lighting devices 216 such as light emitting diodes (LEDs). While in some embodiments, LEDs may be utilized for this purpose, this is not a requirement. The lighting devices 216 may be disposed on the track 202 opposite the carts 204, such that the lighting devices 216 direct light waves to the carts 204 on the portion the track 202 directly below. In some embodiments, the lighting devices 216 are configured to create a plurality of different colors and/or wavelengths of light, depending on the application, the type of plant being grown, and/or other factors. The lighting devices 216 may provide light waves that may facilitate plant growth. Depending on the particular embodiment, the lighting devices 216 may be stationary and/or movable. As an example, some embodiments may alter the position of the lighting devices 216, based on the plant type, stage of development, recipe, and/or other factors. In some embodiments, the lighting devices 216 may further be used for providing one or more signals or visual indications corresponding to a status of the assembly line grow pod 200, a component thereof, and/or one or more of the seeds or plants. For example, the one or more lighting devices 216 may be used to illuminate a cart 204 with an issue.

Additionally, as the plants are provided with light, water, and nutrients, the carts 204 traverse the track 202 of the assembly line grow pod 200. Additionally, the assembly line grow pod 200 may detect a growth and/or fruit output of a plant and may determine when harvesting is warranted. If harvesting is warranted prior to the cart 204 reaching the harvester, modifications to a recipe may be made for that particular cart 204 until the cart 204 reaches the harvester. Conversely, if a cart 204 reaches the harvester component 218 and it has been determined that the plants in that cart 204 are not ready for harvesting, the assembly line grow pod 200 may commission that cart 204 for another cycle. This additional cycle may include a different dosing of light, water, nutrients, and/or other treatment and the speed of the cart 204 could change, based on the development of the plants on the cart 204. If it is determined that the plants on a cart 204 are ready for harvesting, the harvester component 218 may facilitate that process. Status indicators 306, as described in more detail below, may be coupled to the cart 204 may indicate the status of the plants therein and whether they are ready for harvesting. The status indicators 306 can be coupled to other areas. For example, the status indicators may be coupled to the track 202 and light up to show status of whichever cart 204 is located at that location.

Still referring to FIG. 2B, the sanitizer component 220 may clean the cart 204 and/or tray and return the tray 230 to a growing position. The tray 230, the cart 204, both, or neither may be overturned for cleaning. In any event, the tray 230 and/or cart 204 are returned to a growing position such that they may traverse the track 202 and receive and grow plants therein. In the event the tray 230 and/or cart 204 encounters an issue during the sanitizing process, a status indicator 306 may be activated and/or one or more sensors may provide the master controller 206 with information regarding the status of the issue.

As illustrated, the sanitizer component 220 may return the tray 230 to the growing position, which is substantially parallel to ground. Additionally, a seeder head 214 may facilitate seeding of the tray 230 as the cart 204 passes. It should be understood that while the seeder head 214 is depicted in FIG. 2B as an arm that spreads a layer of seed across a width of the tray 230, this is merely an example. Some embodiments may be configured with a seeder head 214 that is capable of placing individual seeds in a desired location.

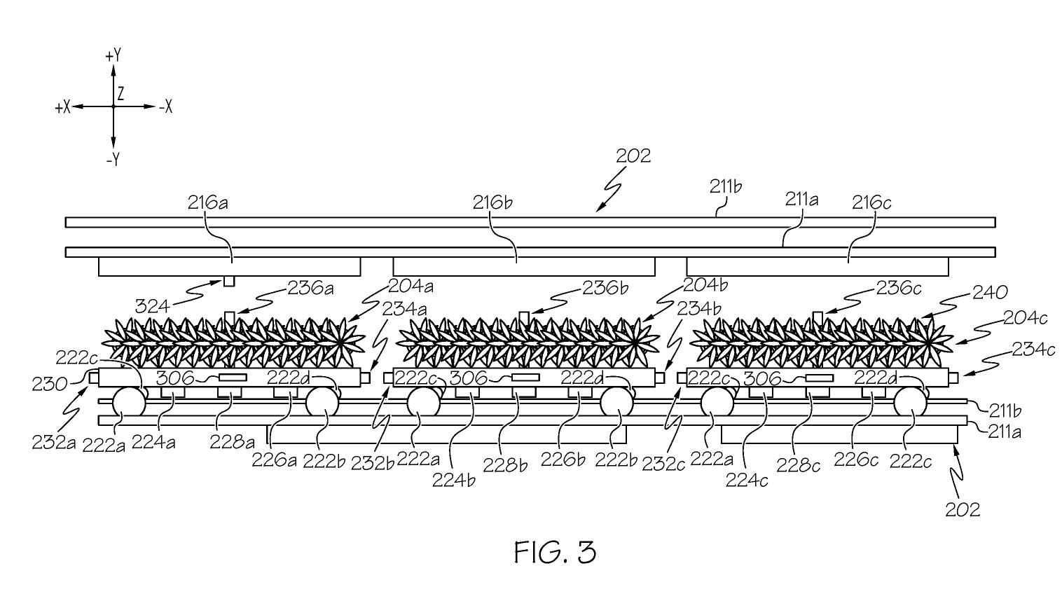

Referring now to FIG. 3, a plurality of carts 204 (e.g., the first cart 204a, the second cart 204b, and the third cart 204c, and collectively referred to as carts 204), each supporting a payload 240 in an assembly line configuration on the track 202, is depicted. In some embodiments, the track 202 may include one or more conductive rails 211a and 211b where at least one wheel 222 of the cart 204 is in electrical contact with the one or more conductive rails 211a and 211b. In such an embodiment, the at least one wheel 222 may relay communication signals and electrical power to the cart 204 as the cart 204 travels along the track 202. In some embodiments, the track 202 includes two conductive rails 211a and 211b as illustrated in FIG. 3. Each of the two conductive rails 211a and 211b (collectively referred to as conductive rails 211) of the track 202 may be electrically conductive. The conductive rails 211 may be configured for transmitting communication signals and electrical power to and from the cart 204 via the one or more wheels 222 rotatably coupled to the cart 204 and supported by the track 202. That is, a portion of the track 202 is electrically conductive and a portion of the one or more wheels 222 is in electrical contact with the portion of the track 202 that is electrically conductive. Although reference herein is made to a track 202 including one or more conductive rails 211, it should be understood that the one or more conductive rails 211 may be any form and type of conductor, which is capable of conducting electrical signals and/or communication signals. Furthermore, the rails 211 may not be conductive in some embodiments.

Since the carts 204 are limited to travel along the track 202, the area of track 202 a cart 204 will travel in the future is referred to herein as “in front of the cart 204” or “leading.” Similarly, the area of track 202 a cart 204 has previously traveled is referred to herein as “behind the cart 204” or “trailing.” Furthermore, as used herein, “above” refers to the area extending from the cart 204 away from the track 202 (i.e., in the +Y direction of the coordinate axes of FIG. 3). “Below” refers to the area extending from the cart 204 toward the track 202 (i.e., in the −Y direction of the coordinate axes of FIG. 3).

Still referring to FIG. 3, the carts 204a-204c may include a tray 230 and/or a payload 240. The tray 230 may support a payload 240 thereon. Depending on the particular embodiment, the payload 240 may contain a plant material (e.g., a plurality of plants, seedlings, seeds, etc.). However, this is not a requirement as any payload 240 may be carried on the tray 230 of the cart 204.

As the carts 204 traverse the track 202, the plurality of plants, seedlings, seeds, etc. may receive water, nutrients, air, and light from systems configured with the assembly line grow pod 200. Light waves may be provided by lighting devices 216, more specifically as depicted, a first lighting device 216a, a second lighting device 216b, and a third lighting device 216c may provide lights waves to carts 204a, 204b, and 204c, respectively. The lighting devices 216 are positioned above the carts 204 such that light waves may be delivered to the plant material that is growing therein. In some embodiments, the lighting devices 216 may also serve as status indicators indicating the status of an issue in the area of the lighting device 216a. As an illustrative example, the first lighting device 216a positioned above first cart 204a provides light to the plurality of plants growing therein. In the event there is an issue with the first cart 204a or the plurality of plants growing therein, the lighting device 216a may be utilized to indicate the status of the issue. The lighting device 216a may intermittently flash to draw attention to the area or even change illumination color. However, this is only an example, other manners of controlling or signaling the status of an issue using the lighting devices 216 may be implemented.

Still referring to FIG. 3, the carts 204a-204c may include a power supply 224a-224c, a drive motor 226a-226c, a cart-computing device 228a-228c, and/or status indicators 306. Collectively, the power supplies 224a-224c, drive motors 226a-226c, and cart-computing devices 228a-228c are referred to as power supply 224, drive motor 226, and cart-computing device 228. The power supply 224 may include a battery, storage capacitor, fuel cell or other source of electrical power. The power supply 224 may be activated in the event the electrical power to the cart 204 via the wheels 222 and the track 202 is terminated or in an embodiment where the rails 211 are not electrified. The power supply 224 may be utilized to power the drive motor 226 and/or other electronics of the cart 204 in the event of a termination of electrical power via the wheels 222 and the track 202. For example, the power supply 224 may provide electrical power to the cart-computing device 228 or one or more sensor modules (e.g., 232, 234, 236). The power supply 224 may be recharged or maintained while the cart 204 is connected to the track 202 or other power source and receiving electrical power from the track 202.

The drive motor 226 is coupled to the cart 204. In some embodiments, the drive motor 226 may be coupled to at least one of the one or more wheels 222 such that the cart 204 is capable of being propelled along the track 202 in response to a received signal. In other embodiments, the drive motor 226 may be coupled to the track 202. For example, the drive motor 226 may be rotatably coupled to the track 202 through one or more gears, which engage a plurality of teeth, arranged along the track 202 such that the cart 204 is propelled along the track 202. That is, the gears and the track 202 may act as a rack and pinion system that is driven by the drive motor 226 to propel the cart 204 along the track 202.

The drive motor 226 may be configured as an electric motor and/or any device capable of propelling the cart 204 along the track 202. For example, the drive motor 226 may be a stepper motor, an alternating current (AC) or direct current (DC) brushless motor, a DC brushed motor, or the like. In some embodiments, the drive motor 226 may comprise electronic circuitry, which may be used to adjust the operation of the drive motor 226, in response to a communication signal (e.g., a command or control signal for controlling the operation of the cart 204) transmitted to and received by the drive motor 226. The drive motor 226 may be coupled to the tray 230 of the cart 204 or may be directly coupled to the cart 204. In some embodiments, more than one drive motor 226 may be included on the cart 204. For example, the wheels 222 may be rotatably coupled to a drive motor 226 such that the drive motor 226 drives rotational movement of the wheels 222. In other embodiments, the drive motor 226 may be coupled through gears and/or belts to an axle, which is rotatably coupled to one or more wheels 222 such that the drive motor 226 drives rotational movement of the axle that rotates the one or more wheels 222.

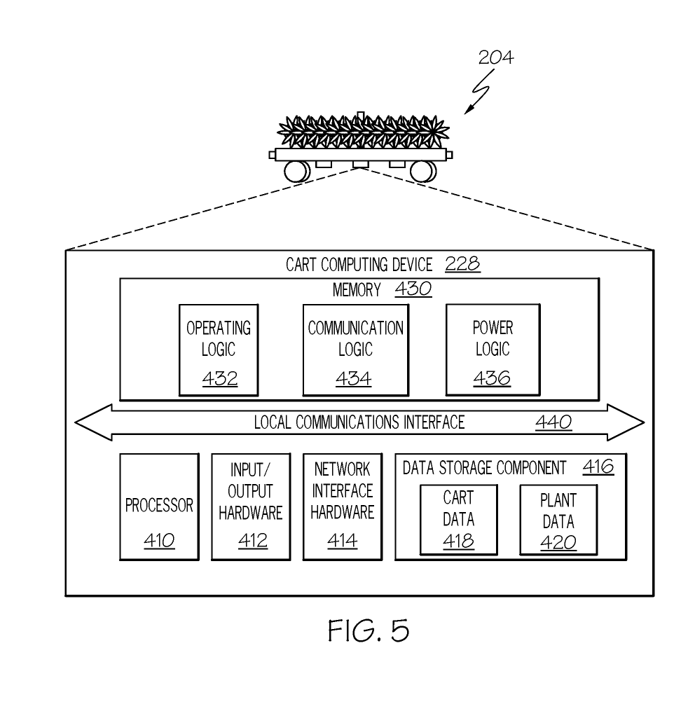

In some embodiments, the drive motor 226 is electrically coupled to the cart-computing device 228. The cart-computing device 228 may electrically monitor and control the speed, direction, torque, shaft rotation angle, or the like, either directly and/or via a sensor that monitors operation of the drive motor 226. In some embodiments, the cart-computing device 228 may electrically control the operation of the drive motor 226. The cart-computing device 228 may receive a communication signal transmitted through the electrically conductive track 202 and the one or more wheels 222 from the master controller 206 or other computing device communicatively coupled to the track 202. The cart-computing device 228 may directly control the drive motor 226 in response to signals received through a network interface hardware 414 (as depicted and described with reference to FIG. 5). In some embodiments, the cart-computing device 228 executes power logic 436 (as depicted and described with reference to FIG. 5) to control the operation of the drive motor 226.

Still referring to FIG. 3, the status indicators 306 may be any device capable of providing a visual indication of status. For example, the status indicators 306 may include light emitting diodes capable of illuminating when operating in a first state and outputting no illumination when operating in a second state. However, this is only one example, the status indicators 306 may have a variety of operating states not limited to the first state and second state referred to herein. That is, the status indicator 306 may be configured to output light at varying frequencies, intensities, wavelengths, and for various durations to indicate the status to be communicated. The status indicators 306 may provide status information by way of varying the color of an LED (e.g., from green to yellow to red indicating the criticality and/or the existence of an issue) or by varying the frequency of an intermittent flash (e.g., steady illumination may indicate no issue whereas rapid flashes may indicate an issue). In some embodiments, the status indicators 306 include a plurality of indicators and each indicator may represent a distinct issue. For example, without limitation, a first indicator may represent power status, a second indicator may represent communication status, a third indicator may represent watering status, and a fourth indictor may represent plant growth status.

The status indicators 306 may be configured as meters with segments indicating, for example, plant growth progress or state of charge of a power supply 224. In some embodiments, the status indicator 306 may be in the form of a light bar or other visual configuration to display a range of operation such that an operator may view the status indicator 306 and determine a present status. The light bar or meter type status indicators 306 may indicate temperature or water level, that is, a parameter with a range of operation, such that an operator may glean a status (e.g., whether or not there is an issue), which is associated with that status indicator 306. Should the operator need additional information, the operator may access the master controller 206 and query the notification system 300 for the additional and/or more detailed information regarding the status provided by the status indicator 306. In some embodiments, a status indicator 306 may include a plurality of indicators (e.g., two or more LED configured in segmented light bar graph display). For example, each of the indicators of the plurality of indicators may correspond to the status of one or more components of the cart 204, or one or more conditions for growing the plant material therein.

In some embodiments, the status indicators 306 may remain in an off-state (no illumination) and only activate when an issue is detected. For example, the status indicators 306 may illuminate the cart 204 or particular area where the issue is present so attention to the problem area may be readily noticed and identified. This may prevent the presence of undesired amounts of light that may adversely affect the growing process. In some embodiments, the amount of light emitted by the status indicators 306 may be such that it does not affect the growth of the plant material. That is, the light emitted by the visual type status indicators 306 do not interfere with the specific wavelength, intensity, etc. of the light that illuminates the plant material. For example, the color of the light emitted by the visual type status indicators 306 may have the same intensity and wavelength as the light provided to the plant material. In another example, the light emitted by the status indicators 306 is provided in the form of a blinking light or the like that does not affect growth of the plant material. In some embodiments, a flashing status indicator 306 may indicate a critical issue whereas a steady state light may indicate a potential issue should the component or system remain unchecked.

In some embodiments, the one or more lighting devices 216 may be used to illuminate a cart 204 with an issue. For example, in the event the first cart 204a has an issue then the lighting device 216a may be illuminated to highlight the first cart 204a. The lighting device 216a may be configured to illuminate a particular color, for example, red, or flash intermittently in order to capture the attention of user or operator of the system. In some embodiments, if the first cart 204a progresses along the track 202 (e.g., in the −X direction of the coordinate axes of FIG. 3) and is now located under lighting device 216b, then lighting device 216b may be configured to illuminate the first cart 204a having the issue.

Still referring to FIG. 3, the cart-computing device 228 may control the drive motor 226 in response to one or more signals received from one of the sensor modules (e.g., 232, 234, 236) included on the cart 204 in some embodiments. The sensor modules (e.g., 232, 234, 236) may include an infrared sensor, a photo-eye sensor, a visual light sensor, an ultrasonic sensor, a pressure sensor, a proximity sensor, a motion detector, a contact sensor, an image sensor, an inductive sensor (e.g., a magnetometer) or other type of sensor capable of detecting at least the presence of an object (e.g., another cart 204 or a track sensor module) and generating one or more signals indicative of the detected event (e.g., the presence of the object). In some embodiments, the sensor modules (e.g., 232, 234, 236) may include a moisture sensor, a water level sensor, a pH sensor, a nutrient sensor, a temperature sensor, a light sensor 324, a contaminant sensor, a plant growth sensor, a color sensor, a camera 310, or the like.

The sensor modules (e.g., 232, 234, 236) may generate one or more signals corresponding to a status, which corresponds to the status of the cart 204 (including a component of the cart 204) and/or the plurality of plants therein. For example, the status of the cart 204 may include operating information including the speed, direction, torque, and/the like of the cart 204. The status of the cart 204 may also include information about the cart 204, for example, the status of a backup battery, whether the drive motor 226 is operating within specified parameters, whether the cart 204 is receiving sufficient power from the track 202, whether one or more wheels 222 of the cart 204 is derailed, a malfunction with the cart 204, or other related information.

In some embodiments, the status indicators 306 may also provide information relating to the growth and/or environmental conditions of the plant material within the cart 204. The status indictors 306 may indicate issues with watering, air quality, temperature, pH levels, lighting, nutrients, gas mixtures, growth rate, color of the plant, the presence of contaminants or a variety of other variables related to growing plants. That is, the status of the plurality of plants may include a plant growth status, a watering status, a nutrient status, a pH status or other information related to the plants growing therein. In some embodiments, the status indicator 306 may be coupled to a cart 204, which is described in more detail herein.

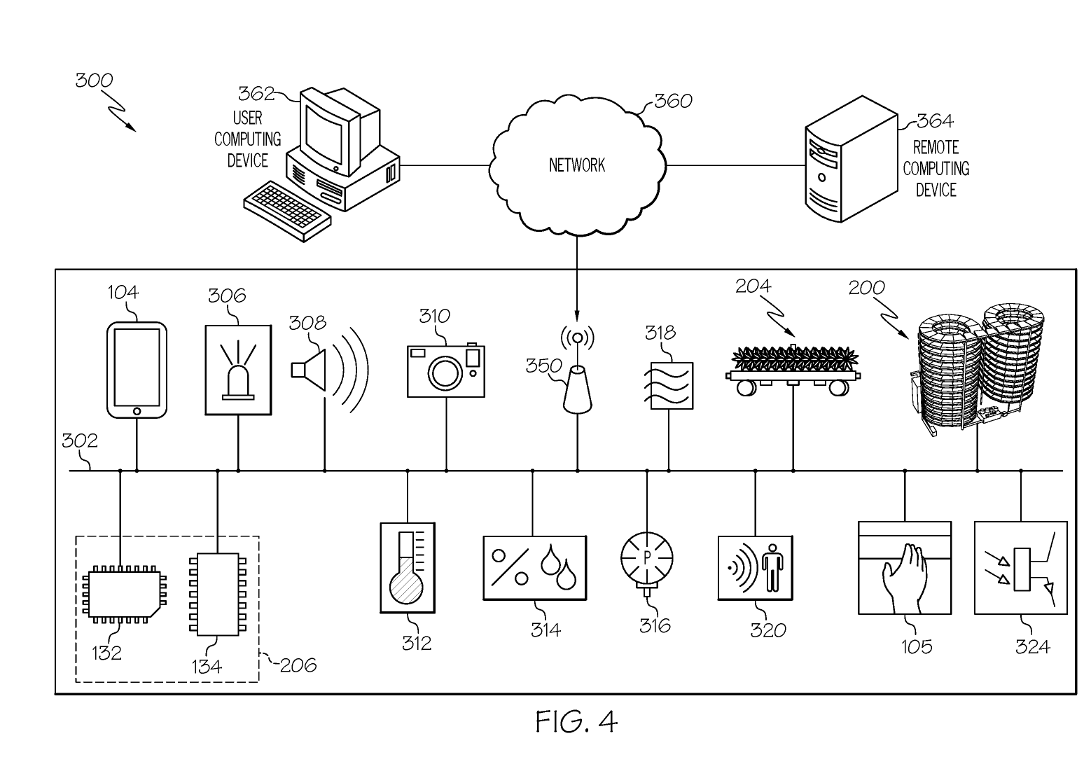

In some embodiments, the sensor modules (e.g., 232, 234, 236) may be communicatively coupled to the master controller 206. The sensor modules (e.g., 232, 234, 236) may generate one or more signals that may be transmitted via the one or more wheels 222 and the track 202. The track 202 and/or the cart 204 may be communicatively coupled to a network 360 (FIG. 4). Therefore, the one or more signals may be transmitted to the master controller 206 via the network 360 over the network interface hardware 414 (FIG. 5) or the track 202. In response, the master controller 206 may generate a notification of the status corresponding to the one or more signals of the sensor modules (e.g., 232, 234, 236).

In some embodiments, the sensor modules (e.g., 232, 234, 236) are communicatively coupled to the cart-computing device 228. The one or more signals generated by the sensor modules (e.g., 232, 234, 236) may correspond to a status of the cart 204, (e.g., a component thereof) and/or the plant material growing therein. Additionally, the cart 204 may include a status indicator 306 communicatively coupled to the cart-computing device 228. The status indicator 306 may include a visual indicator and/or an audible indicator. Visual indicators may include a LED, a display, an OLED, or other device capable of emitting light. The audible indicators may include a speaker, a piezoelectric device, or other device capable of generating an audible sound.

Referring now to FIG. 4, a notification system 300 for an assembly line grow pod 200 is depicted. The notification system 300 utilizes one or more sensors to generate one or more signals corresponding to a status of the assembly line grow pod 200, a component thereof, and/or the plurality of plants growing therein. In some embodiments, the notification system 300 may be communicatively coupled to a network 360 and a user computing device 362, and/or a remote computing device 364. The notification system 300 may have a plurality of components including the master controller 206 having a first processor 132 and first non-transitory computer-readable memory 134 communicatively coupled to the display 104, the status indicator 306, a speaker, one or more sensors, an input device 105, the one or more carts 204, and other components of the assembly line grow pod 200. The one or more sensors may include a camera 310, a temperature sensor 312, a humidity sensor 314 (which may also include a water level sensor and/or a moisture sensor), a pressure sensor 316, a gas composition sensor 318, a motion detector 320, a light sensor 324, and/or other sensors to that are capable of detecting conditions of components, the environment and/or the plants growing within the assembly line grow pod 200. The plurality of components of the notification system 300 may be physically coupled and/or may be communicatively coupled through a communication path 302 and/or network 360. The various components of the notification system 300 and the interaction thereof will be described in detail herein.

The communication path 302 may be formed from any medium that is capable of transmitting a signal such as, for example, conductive wires, conductive traces, optical waveguides, or the like. The communication path 302 may also refer to the expanse in which electromagnetic radiation and their corresponding electromagnetic waves traverse. Moreover, the communication path 302 may be formed from a combination of mediums capable of transmitting signals. In one embodiment, the communication path 302 comprises a combination of conductive traces, conductive wires, connectors, and buses that cooperate to permit the transmission of electrical data signals to components such as processors, memories, sensors, input devices, output devices, and communication devices. Accordingly, the communication path 302 may comprise a bus. Additionally, it is noted that the term “signal” means a waveform (e.g., electrical, optical, magnetic, mechanical or electromagnetic) such as DC, AC, sinusoidal-wave, triangular-wave, square-wave, vibration, and the like, capable of traveling through a medium. The communication path 302 communicatively couples the various components of the notification system 300. As used herein, the term “communicatively coupled” means that coupled components are capable of exchanging signals with one another such as, for example, electrical signals via conductive medium, electromagnetic signals via air, optical signals via optical waveguides, and the like.

Still referring to FIG. 4, the master controller 206 may be any device or combination of components comprising a first processor 132 and a first non-transitory computer-readable memory 134. The first processor 132 of the notification system 300 may be any device capable of executing the machine-readable instruction set stored in the first non-transitory computer-readable memory 134. Accordingly, the first processor 132 may be an electric controller, an integrated circuit, a microchip, a computer, or any other computing device. The first processor 132 may be communicatively coupled to the other components of the notification system 300 by the communication path 302. Accordingly, the communication path 302 may communicatively couple any number of processors with one another, and allow the components coupled to the communication path 302 to operate in a distributed computing environment. Specifically, each of the components may operate as a node that may send and/or receive data. While the embodiment depicted in FIG. 4 includes a single processor, other embodiments may include more than one processor.

The first non-transitory computer-readable memory 134 of the notification system 300 is coupled to the communication path 302 and communicatively coupled to the first processor 132. The first non-transitory computer-readable memory 134 may comprise RAM, ROM, flash memories, hard drives, or any non-transitory memory device capable of storing a machine-readable instruction set such that the machine-readable instruction set can be accessed and executed by the first processor 132. The machine-readable instruction set (e.g., first logic and/or one or more programming instructions) may comprise logic or algorithm(s) written in any programming language of any generation (e.g., 1GL, 2GL, 3GL, 4GL, or 5GL) such as, for example, machine language that may be directly executed by the first processor 132, or assembly language, object-oriented programming (OOP), scripting languages, microcode, etc., that may be compiled or assembled into machine readable instructions and stored in the first non-transitory computer-readable memory 134. Alternatively, the machine-readable instruction set may be written in a hardware description language (HDL) such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 4 includes a single non-transitory computer-readable memory, other embodiments may include more than one memory module.

Still referring to FIG. 4, the notification system 300 may include a display 104 for providing a visual output, for example, a visualization of the status of the grow pod 100, components thereof, and/or the plant growing therein. The display 104 is coupled to the communication path 302. Accordingly, the communication path 302 communicatively couples the display 104 with other modules of the notification system 300. The display 104 may include any medium capable of transmitting an optical output such as, for example, a cathode ray tube, light emitting diodes, a liquid crystal display, a plasma display, or the like. Moreover, the display 104 may be a touchscreen that, in addition to providing optical information, detects the presence and location of a tactile input upon a surface of or adjacent to the display 104. Accordingly, each display 104 may receive mechanical input directly upon the optical output provided by the display 104. Additionally, the display 104 may be the display 104 of a portable personal device such as a smart phone, tablet, laptop or other electronic device. Additionally, it is noted that the display 104 can include one or more processors and one or more non-transitory computer-readable memories. While the notification system 300 includes a display 104 in the embodiment depicted in FIG. 4, the notification system 300 may not include a display 104 or may include many displays 104.

In some embodiments, an input device 105 is a separate device from the display 104. The input device 105 may be coupled to the communication path 302 and communicatively coupled to the first processor 132. The input device 105 may be any device capable of transforming user contact into a data signal that can be transmitted over the communication path 302 such as, for example, a keyboard, a mouse, a button, a lever, a switch, a knob, a touch sensitive interface, a microphone or the like. In some embodiments, the input device 105 is integrated with the display 104, which provides a user the capability of querying the notification system 300 for the status of the assembly line grow pod 200, components thereof, and/or the plants growing therein. It should be understood that some embodiments may not include the input device 105 or may include more than one input device 105.

Still referring to FIG. 4, the notification system 300 may include one or more status indicators 306. In some embodiments, the status indicators 306 may be one or more displays 104 such as a LCD mounted on or near the assembly line grow pod 200. The display 104 may project a graphical representation of the assembly line grow pod 200 with graphical status indicators associated therein. For example, without limitation, the status indicator 306 may include one or more displays 104 having a medium capable of transmitting through an optical output such as a cathode ray tube, a LED, a liquid crystal display, a plasma display, electronic paper (E Ink) display, electroluminescent display, organic light-emitting diode, laser display, or the like, and/or one or more human interface components such as a speaker, touchscreen display, tactile device or the like. The status indicators 306 may include one or more human interface components. The display 104 may be a touch-sensitive display where a user may visually see a graphical status indictor indicating an issue and then select the graphical indictor to learn more information about the issue or begin to resolve the issue. In some embodiments, the display 104 may be, for example, an E-Ink display, that provides textual messages. The textual messages may include status information in natural language or pre-programmed codes that correspond to a particular issue.

The status indicators 306 may be positioned at any location on or around the assembly line grow pod 200. For example, the status indicators 306 may be positioned on an enclosure 102 (FIG. 1) of the grow pod 100 and/or on one or more interior components of the assembly line grow pod 200. The status indicators 306 may communicate information such as the status of the plant material, the status of one or more components of the assembly line grow pod 200, the status of the cart 204, the status of an individual tray 230, the status of the environment (e.g., an internal environment of the grow pod 100), that everything is functioning normally or that there is an issue, or the like.

The status indicators 306 may enable a user to efficiently and rapidly determine a variety of statuses of the assembly line grow pod 200. The information from the status indicators 306 may be a summary or condensed set of information to assist a user in determining if there is an issue or an adjustment is required. Additional information may be provided in more detail to a user by accessing the master controller 206 or a separate computing device (e.g., the user computing device 362 or remote computing device 364). Access may be established, for example, through a website, a mobile application or a terminal in communication with the assembly line grow pod 200.

In some embodiments, the status indicators 306 may incorporate one or more speakers 308 to generate audio sounds, verbal alerts, and/or the like, which may be provided in addition to a visual type status indicator 306 or in lieu of a visual type status indicator 306. In such instances, for example, each cart 204, section of track 202 component, tray 230 and/or section within the tray 230 may have a unique identifier. There may be one or more sensors monitoring a variety of variables, some of which are discussed herein. In response to an issue determined by the master controller 206 and/or the cart-computing device 228 of one or more of the carts 204, the master controller 206 and/or the cart-computing device 228 may generate an electronic signal for output by a speaker 308 or other similar audio device. The audible status generated by the electronic signal may include a buzzing sound generated by a piezoelectric speaker or similar device located near the issue. Similarly, the audible status may comprise a coded message such as an audio version of Morse code or a similarly programmed sequence of pitches, tones, intensities, durations, and frequencies that correlate to an issue and/or location of the issue. In some embodiments, the auditory response may comprise a natural language message. The natural language message may include a description of the issue, the location of the issue (e.g., identified by the unique identifier) and/or other general status information. For example, without limitation, a natural language message may include the statements “Cart #15 is low on water” or “Plant in cart #24, section #10 has not sprouted.”

The notification system 300 may further include one or more sensors communicatively coupled to the master controller 206 and/or one or more cart-computing device 228. The one or more sensors, for example and without limitation may include one or more cameras 310, a temperature sensor 312, a humidity sensor 314 (which may also include a water level sensor and/or a moisture sensor), a pressure sensor 316, a gas composition sensor 318, a motion detector 320, a light sensor 324, and/or other sensors to that are capable of detecting conditions of components, the environment and/or the plants growing within the assembly line grow pod 200. This may further include pH sensors, contaminant sensors, plant growth sensors, color sensors, and/or the like.

In some embodiments, the one or more sensors may include one or more cameras 310. The one or more cameras 310 may be communicatively coupled to the communication path 302 and to the master controller 206 and/or the cart-computing device 228. The one or more cameras 310 may be any device having an array of sensing devices (e.g., pixels) capable of detecting radiation in an ultraviolet wavelength band, a visible light wavelength band, or an infrared wavelength band. The one or more cameras 310 may have any resolution. The one or more cameras 310 may be an omni-directional camera, or a panoramic camera. In some embodiments, one or more optical components such as a mirror, fish-eye lens, or any other type of lens may be optically coupled to each of the one or more cameras 310.

In operation, the one or more cameras 310 capture image data of components of the assembly line grow pod 200, components thereof, and/or plant material growing therein and transmit the image data to the master controller 206 and/or the cart-computing device 228. The image data may be received and processed by the master controller 206 and/or the cart-computing device 228 using one or more image processing algorithms. Any known or yet-to-be developed video and image processing algorithms may be applied to the image data in order to identify objects, determine a location of an object relative to other objects in an environment and/or detect motion of the objects. Example video and image processing algorithms include, but are not limited to, kernel-based tracking (mean-shift tracking) and contour processing algorithms. In general, video and image processing algorithms may detect objects and movement from sequential or individual frames of image data. One or more object recognition algorithms may be applied to the image data to estimate the three-dimensional structure of objects to determine their relative locations to each other. For example, structure from motion, which is a photogrammetric range imaging technique for estimating three-dimensional structures from image sequences, may be used. Object recognition algorithms may include, but are not limited to, scale-invariant feature transform (“SIFT”), speeded up robust features (“SURF”), and edge-detection algorithms. It should be understood that these are only examples of object detection, segmentation, and image analysis algorithms. Any known or yet-to-be-developed object recognition, detection, segmentation, and/or image analysis algorithms may be used to extract and label objects, edges, dots, bright spots, dark spots or even optical characters and/or image fragments within the image data.

Still referring to FIG. 4, the one or more sensors may include a temperature sensor 312 coupled to the communication path 302. The temperature sensor 312 may be any device capable of outputting a temperature signal indicative of a temperature sensed by the temperature sensor 312. As non-limiting examples, the temperature sensor 312 may comprise a thermocouple, a resistive temperature device, an infrared sensor, a bimetallic device, a change of state sensor, a thermometer, a silicon diode sensor, or the like. In some embodiments, one or more temperature sensors 312 may be implemented to determine the temperature in a variety of locations, for example, outside the enclosure 102, inside the enclosure 102 in the environment around the assembly line grow pod 200, and/or near the plants growing in the carts 204. The temperature sensor 312 may provide one or more signals indicative of the temperature at various locations of the grow pod 100.

The one or more sensors may further include a humidity sensor 314, or similarly a water level sensor or a moisture sensor, which is capable of sensing the amount of water in an environment. For example, a humidity sensor 314 may generate one or more signals corresponding to the amount of humidity in an environment. A water level sensor may generate one or more signals corresponding to the amount of water in a container such as the amount of water in the tray 230 for growing plants. A moisture sensor may similarly generate one or more signals capable of determining moisture content within a substance, for example, within a soil for growing plants. In some embodiments, one or more signals may be provided to the master controller 206 and/or the cart-computing device 228 to determine whether the one or more signals indicate a value that is not within a predefined operational range. For example, if the one or more signals from the humidity sensor 314 indicate that the humidity is about 20% and the predefined operational range is defined as 75% to 85%, then the master controller 206 and/or the cart-computing device 228 may determine there is an issue with the humidity. In response to the low humidity indication from the humidity sensor 314, the master controller 206 and/or the cart-computing device 228 may cause the status indicators 306 to be activated indicating the issue.

The one or more sensors may further include a pressure sensor 316, which may be any device capable of sensing the pressure in an environment and/or within a contained space such as with the airflow lines 212. Additionally, the one or more sensors may include a gas composition sensor 318. The gas composition sensor 318 may be any sensor capable of detecting one or more types of gases within an environment and generating one or more signals corresponding to the concentration of the gas within the environment.

Still referring to FIG. 4, the one or more sensors utilized by the notification system 300 may include a motion detector 320. The motion detector 320 may be any device capable of detecting moving objects, for example a person. Such devices may utilize optical, microwave, infrared illumination or acoustic sensors. As used herein the motion detector 320 may be used to detect the motion one or more carts 204 traveling on the track 202, the functionality of one or more components of the assembly line grow pod 200 (e.g., the seeder component 208, the sanitizer component 220, or harvester component 218), and/or the presence of a person or undesired object within the environment of the grow pod. In some embodiments, the motion detector 320 may determine that a cart 204 is not moving along the track 202, as it should. Furthermore, the motion detector 320 may sense the presence of an operator near a display 104 and generate one or more signals indicating the same. As a result, the display 104 may be activated so the operator may interface with it.

In some embodiments, the one or more sensors may include a light sensor 324 that is coupled to the communication path 302 and communicatively coupled to the master controller 206 and/or the cart-computing device 228. The light sensor 324, for example, may be coupled to one or more of the plurality of lighting devices 216 (e.g., lighting device 216a as depicted in FIG. 2B), the track 202 and/or other structures of the assembly line grow pod 200. The light sensor 324 is any sensor capable of generating one or more signals indicative of the presence of light. In some embodiments, the light sensor 324 is a device that measures light intensity, wavelength, and/or frequency. For example, a light sensor 324 may include an optical detector, a light dependent resistor, a photodiode, a phototube and the like to generate the one or more signals corresponding to the detection of light.

Each of the one or more sensors may generate one or more signals in response to the one or more predetermined event or change that the sensor is configured to monitor. The one or more signals generated by the one or more sensors may be received by the master controller 206 and/or the cart-computing device 228 for carrying out monitoring and control operations. Additionally, the one or more signals generated by the one or more sensors may be received by the master controller 206 and/or the cart-computing device 228 for determining the plant recipe and/or determining the status of plant growth. The first processor 132 and/or second processor 410 of the master controller 206 and the cart-computing device 228, respectively, executing a first logic and a second logic, respectively, may generate one or more output signals in response to the one or more signals from the one or more sensors. The one or more output signals may include data signals and/or drive signals for controlling, for example, the display 104 and/or the status indicators 306.

It should be understood that the one or more sensors may correspond to status information including, but not limited to a water level, an air characteristic, a temperature, a pressure, a lighting condition, a measured amount of plant growth, a measured plant color, a measured amount of contaminants, a measured pH, or a measured amount of nutrients, a status of a communications link between cart components, a status of a communications link between the cart 204 and components external to the cart 204, an amount of electrical power supplied to the cart 204, cart movement characteristics, cart component failure indicators and/or the like.

Furthermore, it should be understood that the notification system 300 may further be communicatively coupled to the one or more carts 204 of the assembly line grow pod 200 and utilize the one or more components and systems of the one or more carts 204. In some embodiments, the notification system 300 may be integrated within one or more carts 204 to provide the status of the one or more carts 204. Additionally, the notification system 300 may be communicatively coupled to the components of the assembly line grow pod 200, for example, the seeder component 208, the lighting devices 216, the harvester component 218, and/or the sanitizer component 220. Each of these components may be monitored by the one or more sensors and/or the master controller 206 to assure they are operating within predefined operating parameters.

Still referring to FIG. 4, the notification system 300 may include a communication module 350 that couples to the communication path 302 and communicatively couples to the master controller 206. The communication module 350 may be any device capable of transmitting and/or receiving data via a network 360. Accordingly, communication module 350 can include a communication transceiver for sending and/or receiving any wired or wireless communication. For example, the communication module 350 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, communication module 350 includes hardware configured to operate in accordance with the Bluetooth wireless communication protocol. In another embodiment, communication module 350 may include a Bluetooth send/receive module for sending and receiving Bluetooth communications to/from a network 360.

In some embodiments, the notification system 300 may be communicatively coupled to a user computing device 362 (e.g., a local device) and/or a remote computing device 364 via the network 360. In some embodiments, the network 360 is a personal area network that utilizes Bluetooth technology to communicatively couple the notification system 300 to the user computing device 362 and/or a remote computing device 364. In other embodiments, the network 360 may include one or more computer networks (e.g., a personal area network, a local area network, or a wide area network), cellular networks, satellite networks and/or a global positioning system and combinations thereof. Accordingly, the notification system 300 can be communicatively coupled to the network 360 via wires, via a wide area network, via a local area network, via a personal area network, via a cellular network, via a satellite network, or the like. Suitable local area networks may include wired Ethernet and/or wireless technologies such as, for example, Wi-Fi. Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

Still referring to FIG. 4, as stated above, the network 360 may be utilized to communicatively couple the notification system 300 with a user computing device 362 (e.g., a local device) and/or a remote computing device 364. In some embodiments, the network 360 may communicatively couple the notification system 300 to the internet. That is, the notification system 300 may connect with remote computing devices 364 including but not limited to laptop computers, smart phones, tablet computers, servers, or other networks anywhere in the world.

It should now be understood that the notification system 300 may include a variety of components for sensing the status of the grow pod 100, the assembly line grow pod 200, components thereof, and plants growing therein. The notification system 300 also includes a variety of devices for communicating the status to an operator or user interfacing with the grow pod 100.

Referring now to FIG. 5, a cart 204 having a cart-computing device 228 is depicted. In some embodiments, the notification system 300 may be implemented within a cart 204 of the assembly line grow pod 200. As illustrated, the cart-computing device 228 may include a second processor 410, input/output hardware 412, the network interface hardware 414, a data storage component 416 (which stores systems data 418, plant data 420, and/or other data), and a second non-transitory computer readable memory, the memory component 430. The memory component 430 may store a second logic (e.g., one or more programming instructions) including, for example, the operating logic 432, the communications logic 434, and the power logic 436. The operating logic 432 may include an operating system and/or other software for managing components of the cart-computing device 228. The communications logic 434 and the power logic 436 may each include a plurality of different pieces of logic, each of which may be embodied as a computer program, firmware, and/or hardware, as an example. A local communications interface 440 is also included in the cart-computing device and may be implemented as a bus or other communication interface to facilitate communication among the components of the cart-computing device 228.

The second processor 410 may include any processing component operable to receive and execute instructions (such as from a data storage component 416 and/or the memory component 430). The second processor 410 may be any device capable of executing the machine-readable instruction set (i.e., second logic) stored in the memory component 430. Accordingly, the second processor 410 may be an electric controller, an integrated circuit, a microchip, a computer, or any other computing device. The second processor 410 is communicatively coupled to the other components of the grow pod 100 by a communication path and/or the local communications interface 440. Accordingly, the communication path and/or the local communications interface 440 may communicatively couple any number of processors with one another, and allow the components coupled to the communication path and/or the local communications interface 440 to operate in a distributed computing environment. Specifically, each of the components may operate as a node that may send and/or receive data. While the embodiment depicted in FIG. 5 includes a single processor, other embodiments may include more than one processor.

The input/output hardware 412 is coupled to the local communications interface 440 and facilitates communication between the cart-computing device 228 and other components of the cart 204 such as the sensor modules 232, 234, and 236, the drive motor 226, or the like. The network interface hardware 414 is coupled to the local communications interface 440 and communicatively coupled to the second processor 410, the memory component 430, the input/output hardware 412, and/or the data storage component 416. The network interface hardware 414 may be any device capable of transmitting and/or receiving data via a network 360 (FIG. 4). Accordingly, the network interface hardware 414 can include a communication transceiver for sending and/or receiving any wired or wireless communication. For example, the network interface hardware 414 may include and/or be configured for communicating with any wired or wireless networking hardware, including an antenna, a modem, LAN port, Wi-Fi card, WiMax card, ZigBee card, Bluetooth chip, USB card, mobile communications hardware, near-field communication hardware, satellite communication hardware and/or any wired or wireless hardware for communicating with other networks and/or devices. In some embodiments, the network interface hardware 414 may be utilized to transmit and receive signals to and from the wheels 222 of the cart 204 and the track 202.

The memory component 430 may be configured as volatile and/or nonvolatile memory and may comprise RAM (e.g., including SRAM, DRAM, and/or other types of RAM), ROM, flash memories, hard drives, secure digital (SD) memory, registers, compact discs (CD), digital versatile discs (DVD), or any non-transitory memory device capable of storing machine-readable instructions such that the machine-readable instructions can be accessed and executed by the second processor 410. Depending on the particular embodiment, these non-transitory computer-readable mediums may reside within the cart-computing device 228 and/or external to the cart-computing device 228. The machine-readable instruction set may comprise logic, algorithm(s) and/or one or more programming instructions written in any programming language of any generation (e.g., 1GL, 2GL, 3GL, 4GL, or 5GL) such as, for example, machine language that may be directly executed by the second processor 410, or assembly language, object-oriented programming (OOP), scripting languages, microcode, etc., that may be compiled or assembled into machine readable instructions and stored in the non-transitory computer readable memory, e.g., the memory component 430. In should be understood that logic, algorithms, machine readable instruction set and one or more programming instructions may be used interchangeably herein. Alternatively, the machine-readable instruction set may be written in a hardware description language (HDL) such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 5 includes a single non-transitory computer readable memory, e.g. memory component 430, other embodiments may include more than one memory module.

It should be understood that while the components in FIG. 5 are illustrated as residing within the cart-computing device 228, this is merely an example. In some embodiments, one or more of the components may reside on the cart 204 external to the cart-computing device 228. It should also be understood that, while the cart-computing device 228 is illustrated as a single device, this is also merely an example. In some embodiments, the communications logic 434 and the power logic 436 may reside on different computing devices. As an example, one or more of the functionalities and/or components described herein may be provided by the master controller 206 and/or the remote computing device 252.

Additionally, while the cart-computing device 228 is illustrated with the operating logic 432, the communications logic 434 and the power logic 436 as separate logical components, this is also an example. In some embodiments, a single piece of logic (e.g., the second logic and/or one or more programming instructions) (and/or or several linked modules) may cause the cart-computing device 228 to provide the described functionality.

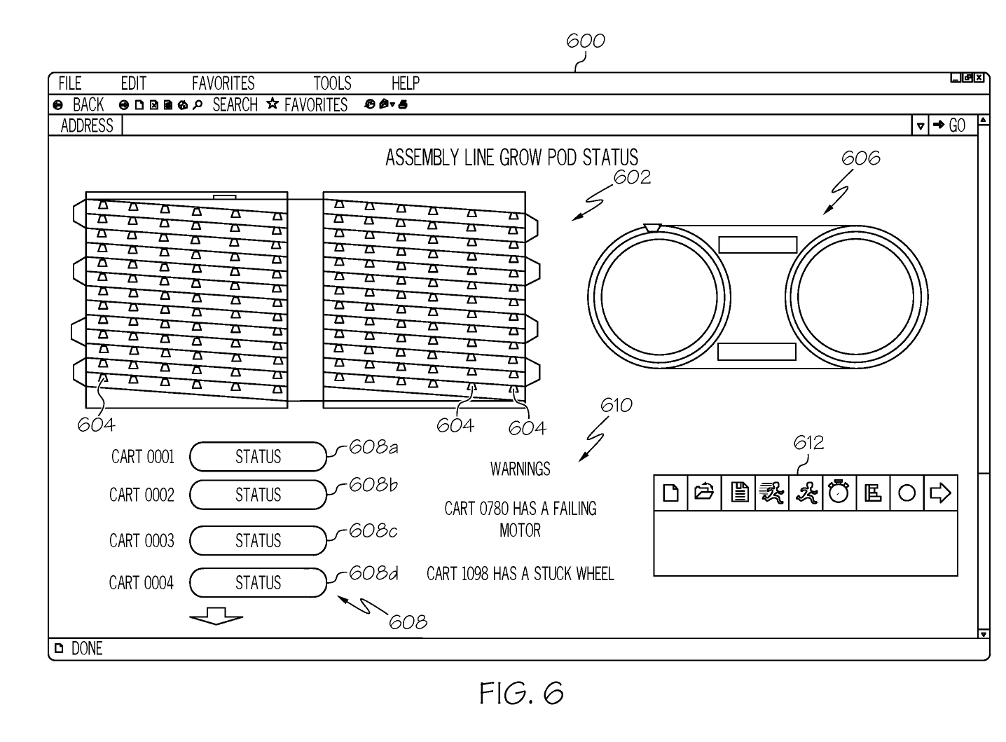

FIG. 6 depicts an assembly line grow pod status interface 600 for providing a visualization of the status of the components of the assembly line grow pod, according to embodiments described herein. In some embodiments, the visualization comprises a text-based notification and/or one or more graphical depictions relating to the determined information. For example, the text-based notification may state that there is an issue with a particular cart and a graphical depiction may illustrate a cart and highlight the component or area of the cart where there is an issue. These visualizations and others may be presented through an assembly line grow pod status interface 600. The assembly line grow pod status interface 600 or variations thereof may be configured for displays including but not limited to computers, smart phones, laptops, or any other computing or display device.

The assembly line grow pod status interface 600 is configured to provide an animated depiction of the carts in the assembly line grow pod. For example, an animated side view of the assembly line grow pod 602 having a visual representation of the carts 604 within the assembly line grow pod may be provided. Each of the visual representation of the carts 604 may have a status associated with it. For example, if the visual representation of a cart 604 is shown in green then the status of the corresponding real cart in the assembly line grow pod may have no issues. Alternatively, if the visual representation of a cart 604 is shown in red then the status of the corresponding real cart in the assembly line grow pod may have one or more issues which may need to be attended to by an operator or the system. An issue with a cart may include a problem with the drive motor, a derailment of one or more wheels, a loss of communication with the cart, a loss of power to the cart or power supply or any other malfunction with the cart. Additionally, an issue with the cart as indicated through the visual representation of the cart 604 may include an issue with the plurality of plants growing within the carts. For example, the visual representation of a cart 604 may indicate an issue with a water level in the tray, for example, that may be outside of the predetermined range such as a water level that is greater or less than the predetermined range for water within the tray, an issue with the light being provided to the plurality of plants in the cart, and/or an issue with the pH, nutrients, air or gas composition being provided to the plurality of plants. Moreover, the one or more sensors of the notification system may determine there is an issue with the color or growth of the plurality of plants within one or more of the carts.

In some embodiments, the assembly line grow pod status interface 600 may include a graphical listing 608 of the status of one or more carts in the assembly line grow pod. The graphical listing 608 may include a visual indicator (e.g., 608A, 608B, 608C, and 608D) representing the status of one or more of the carts. In some embodiments, the visual indicator (e.g., 608A, 608B, 608C, and 608D) may be selected through an input device such that additional information may be provided regarding the status of the selected cart. For example, selecting the visual indicator 608A may provide corresponding warnings, operational statuses, and/or details regarding the plant growth of the plurality of plants growing in “CART 0001.”

In some embodiments, the assembly line grow pod status interface 600 may provide an animated top view of the assembly line grow pod 606. The animated top view of the assembly line grow pod 606 may provide graphical representations and visual indicators of the status of components of the assembly line grow pod and/or problem areas within the grow pod. Such indication may help an operator identify the source of an issue. Additionally, the assembly line grow pod status interface 600 may include a warnings indicator 610 that may illustrate warnings or critical issues with the assembly line grow pod. Additionally, a playback window 612 may be provided such that an operator may select and load a previous status of the assembly line grow pod and track the origination of issues that arose over time.

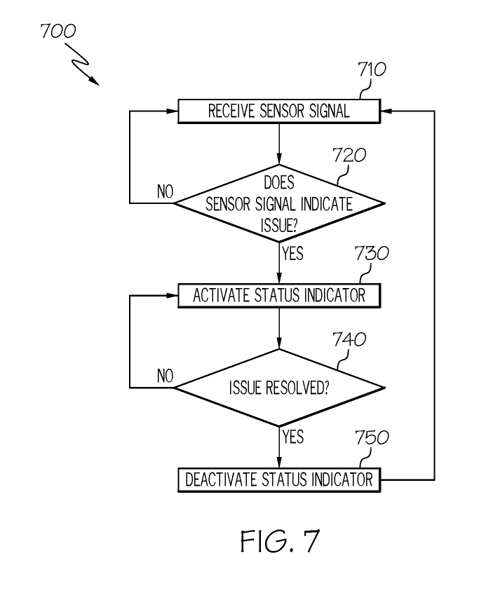

Referring now to FIG. 7, a flowchart 700 for providing a status of the grow pod according to the embodiments herein is depicted. In some embodiments, the logic of the master controller and/or cart-computing device may be configured with the logic depicted in flowchart 700. In some embodiments, the master controller and/or cart-computing device may receive one or more signals from the one or more sensors at block 710. The master controller and/or cart-computing device may then determine whether the one or more signals from the one or more sensors indicate an issue, at block 720. In some embodiments, the types of information and the trigger levels for indicating an issue may be predetermined determined and configured within the first logic and/or second logic of the master controller and/or the cart-computing device, respectively. For example, a user may configure the logic (e.g. the first logic and/or second logic) to illuminate a status indicator when one or more sensors detect that the water content for a plant in a cart is below 50%, or optionally below 20% or optionally below 10%. Alternatively, the types of information and the trigger levels for indicating an error may be automatically determined. For example, when there is a loss of communications with a component, a wheel becomes derailed, or there is a loss of power.

In response to determining that the one or more signals from the one or more sensors indicate an issue at block 720, the master controller and/or cart-computing device, at block 730, activates a status indicator. For example, the cart-computing device may cause a status indicator coupled to the cart to output in a first state, (e.g., an illuminated state). In some embodiments, upon determining from the one or more sensors that an issue is present, at block 720, the cart-computing device may also transmit a notification to the master controller indicating the issue. In such an instance, the master controller may generate for display a visualization of the issue. In some embodiments, the master controller may determine the criticality of the issue and then generate the visualization of the issue to indicate the criticality. As used herein, “criticality” refers to the importance and/or severity of the issue. The criticality may be a predefined or may be determined based on the status of other components, systems, or measure of the plant material. The notification system may determine “criticality” from the occurrence of an event such as a cart becoming derailed. For example, the fact that a cart becomes derailed may be determined purely based on its occurrence. In other instances, the “criticality” of a particular issue may be based on additional factors or the status of other components, systems, or measure of the plant material. For example, the occurrence of a plant not growing at the expected rate may be an issue, however, may only become a severe issue the farther behind its expected growth falls. That is, the determination of “criticality” may be based on how far behind the growth of the plant is in relation to the expected growth.

By way of additional examples, if the cart-computing device transmits a notification indicating there is an issue with the water level in the tray of a particular cart, the master controller may determine that the criticality of the issue is low since the particular cart may receive water shorty. However, if the cart-computing device transmits a notification indicating that one or more of the wheels have become derailed from the track, the master controller may determine that the criticality of the issue to be high since a derailed cart may affect the entire assembly line grow pod and may not be able to be resolved by the system. That is, the resolution may require an operator to enter the grow pod and correct the position of the derailed cart. In some embodiments, the notification system may cause the assembly line grow pod to implement a corrective action or stop an operation of the system to avoid additional issues. For example, if a cart is determined to have become derailed, the notification system may stop movement of the carts in the assembly line grow pod.

In some embodiments, upon determining the presence of an issue at block 720, the master controller and/or the cart-computing device may generate a message that includes an indication of the issue with the cart, the assembly line grow pod, a component thereof, and/or the plurality of plants growing therein, and cause a communication module to transmit the message to an external device. For example, the master controller and/or the cart-computing device may generate a text message, email message, or other form of electronic message indicating an issue, for example, a derailed cart, and transmit the message to an external device using the communication module. In some embodiments, the master controller and/or the cart-computing device may determine a resolution to the issue with the cart and include the resolution in the message. The external device may be a smart phone, laptop computer, tablet computer or any other device capable of receiving an electronic message from the network.

In some embodiments, the master controller and/or the cart-computing device may determine whether the grow pod can address the issue. For example, a loss of communications with a cart may be determined to be remedied by cycling the power to a portion of the track that supports the cart with the issue. That is, cycling the power off and then back on may allow the cart-computing device to reset and reestablish communications. In determining that the issue may be addressed automatically by the grow pod, (i.e., without service from an operator), the master controller and/or the cart-computing device may determine the amount of time required to fix the issue. Additionally, the master controller or the cart-computing device may generate a first message including a notification of the issue, the resolution (e.g., the steps to be taken to resolve the issue), and the amount of time required to fix the issue. The first message may be communicated to an external device via the communication module. In some embodiments, the master controller or the cart-computing device may generate a second message indicating the issue is addressed once the resolution is complete. The second message may be communicated to an external device via the communication module.

However, in the event the master controller and/or the cart-computing device determine that the issue cannot be resolved, the master controller and/or the cart-computing device may proceed with activating the status indicator, at block 730. Additionally, the master controller may generate a notification for transmitting via the communication module that an issue exists that requires service, for example, by an operator. In some embodiments, the master controller and/or the cart-computing device may also determine whether a workaround may be implemented to allow the grow pod to continue to operate while the issue is addressed. For example, if the issue is that a drive motor of a cart has failed, then the master controller may determine that one or more other carts on the track may push and/or pull the cart along the track until the failed drive motor is fixed. That is, the carts on the track may continue to traverse the track and receive the prescribed light, nutrients, water, etc. while the issue is resolved.

In some embodiments, activating the status indicator, at block 730, may include generating for display a visualization of the issue. For example, the master controller may generate or update the data for presenting in a graphical user interface, for example, the assembly line grow pod status interface 600, as shown and described in FIG. 6.

However, if the one or more signals from the one or more sensors do not indicate an issue, the master controller and/or the cart-computing device will continue to receive the one or more signals from the one or more sensors, at block 710. Similarly, in the event of an issue the master controller and/or the cart-computing device may also continue to monitor the signals from the one or more sensors, at block 740, to determine whether the issue has been resolved.

In some embodiments, to determine an issue has been resolved a confirmation may be required from the user. For example, the activation of a status indicator may prompt a user to provide an acknowledgment or response. The user may respond through any communicatively coupled means such as a remote computing device or a touch enable display communicatively coupled with the master controller and/or the cart-computing device. The response may be an acknowledgement of the issue and/or confirmation that the issue was resolved.

Additionally, the user may request a summary of the status of the assembly line grow pod or may request the status of a specific section or cart. Upon receiving a response from the notification system, a user may request, again either through a tactile input device or verbally through a microphone, additional information relating to the issue. For example, if the status indicator states that a cart battery is low, then a user may ask for a specific state of charge battery level to determine if further attention is required. Similarly, if pH is indicated as being outside the desired parameters, the user may request information such as the exact pH level or for how long the pH has been outside of the desired parameter.

In response to determining the issue has been resolved at block 740, the master controller and/or the cart-computing device, at block 750, may deactivate the status indicator. If the issue remains unresolved, the master controller and/or the cart-computing device continue to monitor the status until the issue is resolved.

As illustrated above, various embodiments for providing status information through the implementation of status indicators with an assembly line grow pod are disclosed. These embodiments provide a user with a method of efficiently determining the status of the plant material components. These embodiments may create alerts that indicate, for example, whether the cart is powered by battery or otherwise, whether the cart is in communication with the master controller, the status of a battery powering components of the cart, the status of a motor driving the cart, or whether the cart is operating within particular specifications and/or parameters. Additionally, the status information of the cart, for example, may include whether the cart is on the track or has become derailed or whether there are any other mechanical issues that require attention. The status indicators may further indicate a status of the plants growing in the grow pod and whether there are issues related to the growing process.

Accordingly, some embodiments may include an assembly line grow pod that includes one or more sensors for monitoring and detecting issues with components of the assembly line grow pod and growth status of the plant material and one or more status indicators for indicating the status of the components of the assembly line grow pod or growth status of the plant material where the status indicators include at least one of a visual type status indicator or an audio type status indicator.

While particular embodiments and aspects of the present disclosure have been illustrated and described herein, various other changes and modifications can be made without departing from the spirit and scope of the disclosure. Moreover, although various aspects have been described herein such aspects need not be utilized in combination. Accordingly, it is therefore intended that the appended claims cover all such changes and modifications that are within the scope of the embodiments shown and described herein.

It should now be understood that the embodiments disclosed herein includes systems, methods, and non-transitory computer-readable mediums for providing an assembly line grow pod. It should also be understood that these embodiments are merely exemplary and are not intended to limit the scope of this disclosure.

What is claimed is:

1. An assembly line grow pod notification system comprising:
a status indicator; and
a cart containing one or more plants therein, the cart comprising:
one or more sensors, and
a cart-computing device communicatively coupled to the one or more sensors and the status indicator, the cart-computing device comprising a processor and a non-transitory, processor-readable storage medium comprising one or more programming instructions thereon that, when executed, cause the processor to:
receive, from the one or more sensors, one or more signals that correspond to a status of the cart and one or more characteristics of the one or more plants,
determine information regarding the status from the one or more signals, and
direct the status indicator to output a notification signal that corresponds to the determined information.

2. The assembly line grow pod notification system of claim 1, wherein the determined information includes an operational state of the cart.

3. The assembly line grow pod notification system of claim 2, wherein the operational state of the cart includes at least one of the following: a status of a communications link between one or more cart components, a status of a communications link between the cart and components external to the cart, an amount of electrical power supplied to the cart, cart movement characteristics, or a cart component failure indicator.

4. The assembly line grow pod notification system of claim 1, wherein the determined information includes at least one of the following: a water level, an air characteristic, a temperature, a pressure, a lighting condition, a measured amount of plant growth, a measured plant color, a measured amount of contaminants, a measured pH, or a measured amount of nutrients.

5. The assembly line grow pod notification system of claim 1, wherein the status indicator includes a plurality of indicators and each indicator of the plurality of indicators corresponds to a particular notification signal for one or more components of the cart.

6. The assembly line grow pod notification system of claim 1, further comprising a master controller communicatively coupled to the cart-computing device and a communication module communicatively coupled to the master controller, wherein the master controller:
receives, from the cart-computing device, the determined information,
generates for display a visualization corresponding to the determined information, and
transmits the visualization corresponding to the determined information, via the communication module, to an external device.

7. The assembly line grow pod notification system of claim 1, further comprising a master controller communicatively coupled to the cart-computing device, wherein the master controller:
receives, from the cart-computing device, the determined information,
determines whether the determined information indicates an issue,
determines whether an operator is needed to address the issue,
in response to determining that the operator is not needed to address the issue, implements a resolution, and
in response to determining that the operator is needed to address the issue, generates a first message indicating a presence of the issue.

8. The assembly line grow pod notification system of claim 7, wherein the master controller:
in response to determining that the operator is not needed to address the issue, determines an amount of time to implement the resolution, and
generates a second message indicating that the issue is addressed.

9. An assembly line grow pod comprising:
a master controller;
a cart comprising:
a tray supporting a plurality of plants, and
a cart-computing device communicatively coupled to the master controller; and
one or more sensors communicatively coupled to the cart-computing device,
wherein:
the one or more sensors generate one or more signals corresponding sensed information relating to at least one of the following: the cart or the plurality of plants,
the cart-computing device performs at least the following:
receive, from the one or more sensors, the one or more signals,
determine whether the one or more signals indicate an issue, and
transmit a notification to the master controller indicating the issue, and
the master controller performs at least the following:
receives, from the cart-computing device, the notification indicating the issue,
determines a criticality of the issue, and
generates a visualization of the issue, the visualization indicating the criticality of the issue.

10. The assembly line grow pod of claim 9, further comprising a display communicatively coupled to the master controller, wherein the display presents the visualization of the issue with the cart indicating the criticality of the issue.

11. The assembly line grow pod of claim 9, further comprising a communication module communicatively coupled to the master controller, wherein the master controller:
generates a message that includes an indication of the issue with the cart, and
causes the communication module to transmit the message to an external device.

12. The assembly line grow pod of claim 11, wherein the master controller:
determines a resolution to the issue with the cart and wherein the message further includes the resolution to the issue with the cart.

13. The assembly line grow pod of claim 9, wherein a status corresponding to the plurality of plants includes the status of at least one of the following: a water level, an air characteristic, a temperature, a pressure, a lighting condition, a measured amount of plant growth, a measured plant color, a measured amount of contaminants, a measured pH, or a measured amount of nutrients.

14. The assembly line grow pod of claim 9, wherein a status corresponding to the cart includes the status of at least one of the following: a status of a communications link between one or more cart components, a status of a communications link between the cart and components external to the cart, an amount of electrical power supplied to the cart, cart movement characteristics, or a cart component failure indicator.

15. The assembly line grow pod of claim 9, wherein:
the one or more sensors comprise a camera communicatively coupled to the master controller, and
the master controller:
receives image data from the camera, the image data including images of the cart, and
determines the issue with the cart based on the image data.

16. The assembly line grow pod of claim 9, further comprising a track having one or more rails, wherein the one or more rails communicatively couple the master controller to the cart-computing device.

17. A method for providing a status of an assembly line grow pod, the method comprising:
receiving, from one or more sensors within the assembly line grow pod, one or more signals corresponding to information relating to at least one of the following: a water level, an air characteristic, a temperature, a pressure, a lighting condition, a measured amount of plant growth, a measured plant color, a measured amount of contaminants, a measured pH, or a measured amount of nutrients, a status of a communications link between cart components, a status of a communications link between the cart and components external to the cart, an amount of electrical power supplied to the cart, cart movement characteristics, or a cart component failure indicator;
determining whether the one or more signals indicate an issue;
generating a visualization corresponding to the issue; and
causing a display to present the visualization of the issue.

18. The method of claim 17, wherein:
the one or more signals indicate the issue with a component of the assembly line grow pod, and
the component of the assembly line grow pod includes at least one of the following: a track, a seeder component, a harvester component, or a sanitizer component.

19. The method of claim 17, wherein the display comprises a user interface that receives inputs from a user corresponding to a query of a state of the assembly line grow pod.

20. The method of claim 17, further comprising:
generating a message that includes an indication of the issue; and
transmitting the message to an external device.
